(19) United States
(12) Patent Application Publication
(10) Pub. No.: US 2003/0041062 A1
(43) Pub. Date: Feb. 27, 2003

(54) Computer readable medium, system, and method for data analysis

(76) Inventors: Kayoko Isoo, Kawasaki-shi (JP); Kyoko Makino, Kawasaki-shi (JP); Seiji Iwata, Hachioji-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/212,726

(22) Filed: Aug. 7, 2002

(30) Foreign Application Priority Data
Aug. 8, 2001 (JP) 2001-241131
Jul. 23, 2002 (JP) 2002-214324

(51) Int. Cl. G06F 7/00

(52) U.S. Cl. 707/9

(57) ABSTRACT

In this invention, data elements to be used for analysis can easily be changed. A recording medium of this invention includes a program code that records in a database dictionary information which is used for processing of determining whether a predetermined data element is contained in data to be analyzed and links a data element and category information representing at least one category to which the data element belongs, a program code that receives a designation of the category, and a program code that extracts a data element linked to category information representing the designated category by referring to the database and sets the extracted data element as the predetermined data element to be used for determination in the processing.

### CROSS-REFERENCE TO RELATED APPLICATIONS

This application is based upon and claims the benefit of priority from the prior Japanese Patent Applications No. 2001-241131, filed Aug. 8, 2001; and No. 2002-214324, filed Jul. 23, 2002, the entire contents of both of which are incorporated herein by reference.

### BACKGROUND OF THE INVENTION

1. Field of the Invention

The present invention relates to a computer readable medium, system, and method used for data analysis such as data mining.

2. Description of the Related Art

Detailed examples of text mining techniques are techniques for understanding a context on the basis of text data and executing text data summary extraction, text data classification, or text data search, techniques for extracting knowledge from text data, or techniques for acquiring information (quantitative information) quantified from information (qualitative information) described by a text. The text mining techniques sometimes include a technique for analyzing a result obtained by data mining for text data.

A text mining system (mining engine) executes analysis processing using a concept definition dictionary.

FIG. 8 is a block diagram showing an example of a conventional text mining system.

A text mining system 1 mainly comprises an input unit 2, information extracting unit 3, output unit 4, and concept definition dictionary 5.

Various kinds of data are recorded in the concept definition dictionary 5. Various kinds of text elements that construct information described by a text and attribute information (e.g., attribute IDs) corresponding to the text elements are recorded in the concept definition dictionary 5.

The text elements and attribute IDs recorded in the concept definition dictionary 5 are used as a determination criterion for analysis processing. For example, words, phrases, clauses, sentences, and the like are recorded as text elements.

In the example shown in FIG. 8, attribute ID “G001” corresponds to text element “leading by one step”. In addition, attribute ID “G009” corresponds to text element “POS result was satisfactory”. Each attribute ID represents the characteristic of a corresponding text element and is used for analysis processing.

The input unit 2 inputs collected daily report data 61 to 6n, i.e., data to be analyzed.

The information extracting unit 3 extracts daily report data containing a text element recorded in the concept definition dictionary 5 from the input daily report data 61 to 6n. The information extracting unit 3 executes data mining on the basis of the extracted daily report data and the attribute ID of the text element contained in the extracted daily report data. For example, daily report data containing a text element whose attribute ID indicates “good news” is determined by the information extracting unit 3 as “good daily report” and extracted.

The output unit 4 displays the text mining result by the information extracting unit 3.

Thus, daily report data 7 determined as “good daily report” from the daily report data 61 to 6n can be displayed.

In the above text mining system 1, to change the contents of text mining, the contents recorded in the concept definition dictionary 5 must be changed (e.g., revised, corrected, replenished, deleted, or edited).

For example, a user may want to do text mining using only some of the text elements recorded in the concept definition dictionary 5.

In this case, the user must create new dictionary information from only pieces of information including the text elements to be used and attribute IDs belonging to them and change dictionary designation such that the information extracting unit 3 accesses the newly created dictionary.

In changing the concept definition dictionary 5, the user must edit a concept definition dictionary program using, e.g., a text editor, or input a command for instructing dictionary change.

It is difficult for a user who is unfamiliar to the structure of the text mining system 1 to change the contents of the concept definition dictionary 5 or the settings of the dictionary accessed by the information extracting unit 3.

Hence, operation for changing the concept definition dictionary program using a text editor, operation for changing the concept definition dictionary 5 by inputting a command, and operation of designating a dictionary to be used must be done by a technician who knows the structure of the text mining system 1 well.

Even when a user who is familiar to the structure of the text mining system 1 executes editing operation using a text editor or the like, a bug based on a coding error or the like may occur.

### BRIEF SUMMARY OF THE INVENTION

It is an object of the present invention to provide a computer readable medium, system, and method that make it possible to easily change a dictionary database that records a data element which is used as a determination criterion for data analysis and for which it is determined whether the data element is contained in data to be analyzed.

According to a mode of the present invention, there is provided a computer readable medium having computer readable program code means embodied therein, the computer program code means comprising

a computer readable program code that records in a dictionary database dictionary information which is used for processing of determining whether a predetermined data element is contained in data to be analyzed and links a data element and category information representing at least one category to which the data element belongs,

a computer readable program code that receives a designation of the category, and

a computer readable program code that extracts a data element linked to category information representing the designated category by referring to the dictionary database and sets the extracted data element as the predetermined data element to be used for determination in the processing.

According to another mode of the present invention, there is provided a data analysis system which executes processing of determining whether a predetermined data element is contained in data to be analyzed, comprising

a recording unit that records in a dictionary database dictionary information which links a data element and category information representing at least one category to which the data element belongs,

a category designating unit that receives a designation of the category, and

an extracting unit that extracts a data element linked to category information representing the designated category by referring to the dictionary database and sets the extracted data element as the predetermined data element to be used for determination in the processing.

According to still another mode of the present invention, there is provided a data analysis method of executing processing of determining whether a predetermined data element is contained in data to be analyzed, comprising

recording in a dictionary database dictionary information which links a data element and category information representing at least one category to which the data element belongs,

receiving a designation of the category, and

extracting a data element linked to category information representing the designated category by referring to the dictionary database and setting the extracted data element as the predetermined data element to be used for determination in the processing.

Additional objects and advantages of the present invention will be set forth in the description which follows, and in part will be obvious from the description, or may be learned by practice of the present invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the present invention and, together with the general description given above and the detailed description of the preferred embodiments given below, serve to explain the principles of the present invention.

FIG. 1 is a block diagram showing an example of a data element designating system according to the first embodiment of the present invention;

FIG. 2 is a view showing a window displayed by a category designating unit;

FIG. 3 is a flow chart related to a data analysis method executed by the data element designating system and text mining system according to the first embodiment of the present invention;

FIG. 4 is a block diagram showing an example of a data element designating system according to the second embodiment of the present invention;

FIG. 5 is a flow chart related to a data analysis method executed by the data element designating system, text mining system, and analysis result totalizing system according to the second embodiment of the present invention;

FIG. 6 is a view showing a window displayed by a category designating unit according to the fourth embodiment of the present invention;

FIG. 7 is a block diagram showing a use form of a data element designating system according to the fifth embodiment of the present invention; and

FIG. 8 is a block diagram showing an example of a conventional text mining system.

### DETAILED DESCRIPTION OF THE INVENTION

The embodiments of the present invention will be described below with reference to the accompanying drawing. (First Embodiment) In this embodiment, a data element designating system will be described, which allows even a user who is unfamiliar to the structure of a text mining system to easily designate a text element to be used for text mining using a GUI (Graphical User Interface).

The following embodiments assume that data to be analyzed is text data. However, the data to be analyzed may be non-text data such as image data or voice data or a combination of various kinds of data.

In the following embodiments, since the data to be analyzed is text data, text elements and their attribute IDs are recorded in a dictionary. However, when the data to be analyzed is image data or voice data, data elements as image data or voice data and their attribute IDs are recorded in the dictionary. The type of data elements recorded in the dictionary only need to match with the type of data to be analyzed.

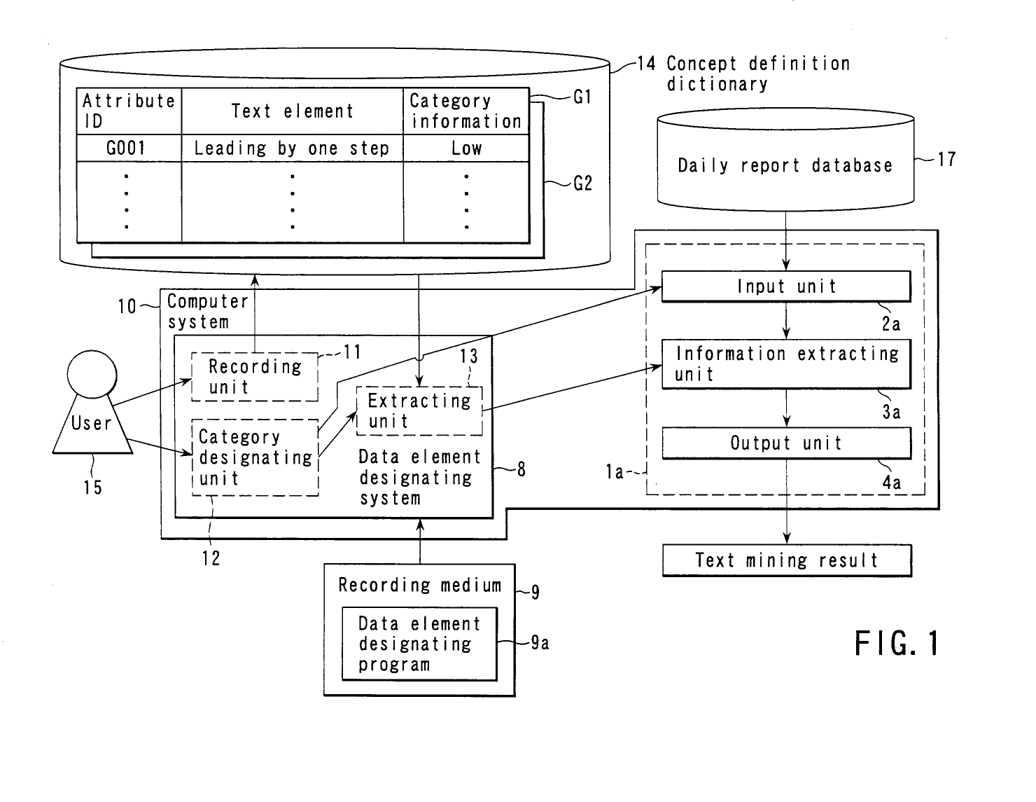

FIG. 1 is a block diagram showing an example of a data element designating system according to this embodiment.

A computer system 10 loads and executes a data element designating program 9a recorded on a recording medium 9.

The data element designating program 9a loaded to the computer system 10 makes the computer system 10 function as a data element designating system 8.

The data element designating system 8 comprises a recording unit 11, a category designating unit 12, and an extracting unit 13.

The recording unit 11 records in a concept definition dictionary 14 information that links a text element to its attribute ID and category information representing the category to which the text element belongs. The recording unit 11 receives the information in which the text element, attribute ID, and category information are linked to each other from, e.g., a user 15 or another unit and records the information.

The user 15 inputs information using the GUI function of the recording unit 11. For example, the recording unit 11 displays a table used to input information in which the text element, attribute ID, and category information are linked to each other. The user describes each information in the table. The recording unit 11 loads the contents described in the table and records them in the concept definition dictionary 14.

In the concept definition dictionary 14, for example, information in which text elements, attribute IDs, and category information are linked to each other are managed in a table format. In this embodiment, assume that the concept definition dictionary 14 contains a plurality of pieces of dictionary information G1 and G2.

Table 1 shows an example of the dictionary information G1 contained in the concept definition dictionary 14.

TABLE 1
Dictionary information G1

| Attribute | | Category |
|---|---|---|
| ID | Text element | information |
| G001 | Leading by one step | Low |
| G002 | Nomination buying | Medium |
| G003 | Monthly sales | Low |
| G004 | Quantity sold is | Medium |
| | constant | |
| G005 | Hit | Medium |
| G006 | Good repute | Medium |
| G007 | Shipment was active | Medium |
| G008 | Quick turnover | Medium |
| G009 | POS result was | High |
| | satisfactory | |
| G010 | POS result increases | High |
| G011 | Sale expansion | Medium |
| G012 | Sales are good | High |

The dictionary information G1 shown in Table 1 is an importance classification dictionary. In the dictionary information G1, text elements are grouped into “high”, “medium”, and “low”. Category information represents a degree of importance.

For example, attribute ID “G001” representing “good news” and category information “low” are linked to text element “leading by one step”. The remaining text elements, attribute IDs, and category information also have similar relationships.

Table 2 shows an example of the dictionary information G2 contained in the concept definition dictionary 14.

TABLE 2
Dictionary information G2

| Attribute | | Category |
|---|---|---|
| ID | Text element | information |
| G013 | Drink | Drink |
| G014 | Magazine | Magazine |
| G015 | Book order | Magazine |
| G016 | Orange juice | Drink |
| G017 | Green tea | Drink |
| G018 | Monthly ◯◯ | Magazine |
| G019 | Weekly magazine | Magazine |

The dictionary information G2 shown in Table 2 is an article name classification dictionary. In the dictionary information G2, text elements are grouped into articles names “magazine” and “drink”. Category information represents an article.

The category designating unit 12 displays a window for causing the user to designate the category of the text element to be used for text mining and receives a designation from the user.

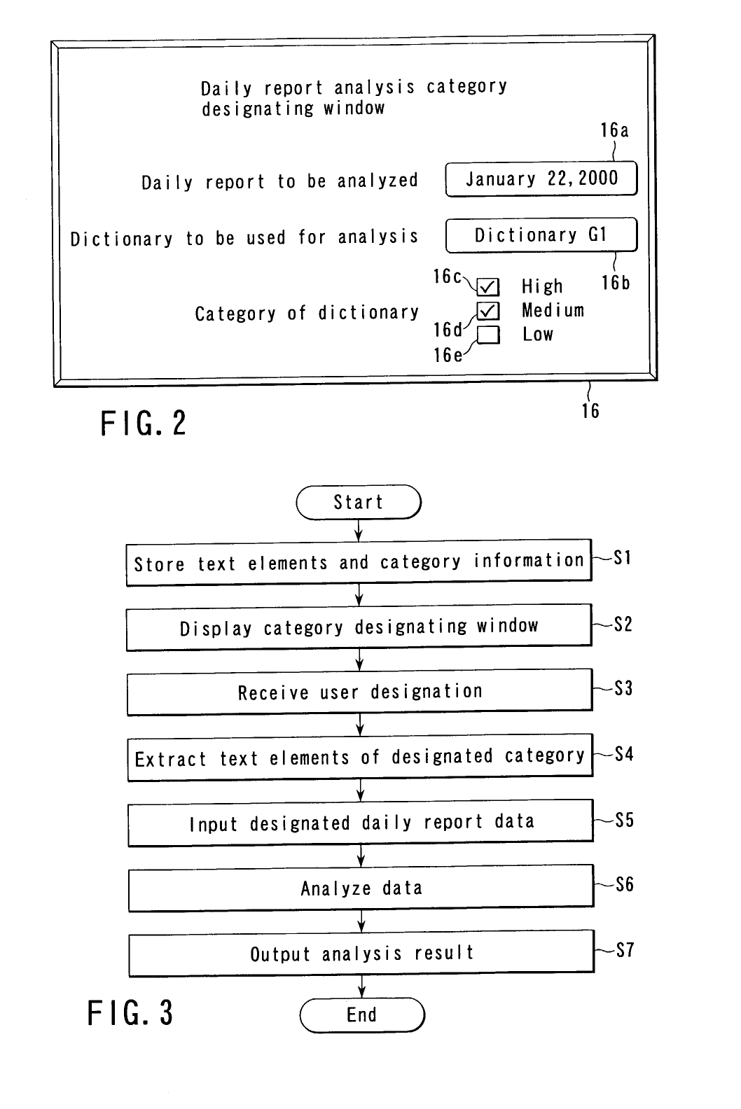

FIG. 2 is a view showing a window displayed by the category designating unit 12.

A region 16a used to designate the date of daily report data to be analyzed, a region 16b used to designate use of one of the plurality of dictionary information G1 and G2 contained in the concept definition dictionary 14, and check boxes 16c to 16e used to designate category information are laid out on a category designating window 16. In the example shown in FIG. 2, date “January 22”, dictionary information “G1”, and category information “high” and “medium” are designated.

The category designating unit 12 outputs to an input unit 2a an input instruction of daily report data related to date “January 22” designated on the category designating window 16.

The category designating unit 12 supplies to the extracting unit 13 a notification representing that the dictionary information “G1” and pieces of category information “high” and “medium” are designated on the category designating window 16.

The extracting unit 13 accesses the concept definition dictionary 14 and extracts text elements linked to pieces of category information “high” and “medium” designated by the user, and their attribute IDs from the dictionary information G1 designated by the user, and supplies the text elements and attribute IDs to an information extracting unit 3a.

A daily report database 17 records daily report data.

Table 3 shows an example of daily report data recorded in the daily report database 17.

TABLE 3
Daily report data

| Daily | |
|---|---|
| report | |
| number | Daily report data |
| N001 | Daily report data on January 22: Last |
| | month, POS result was satisfactory |
| N002 | I think we are leading by one step |
| N003 | We made arrangements about sale |
| | expansion method |
| N004 | Merchandise shipment at weekend was |
| | reported active regardless of snow |
| | Sales are continuously good from |
| N005 | beginning of this year |

In the example shown in Table 3, daily report numbers “N001” to “N005” represent date “January 22”.

A text mining system la comprises the input unit 2a, the information extracting unit 3a, and an output unit 4a.

The input unit 2a receives from the daily report database 17 daily report data related to designated date “January 22” in accordance with an instruction from the category designating unit 12.

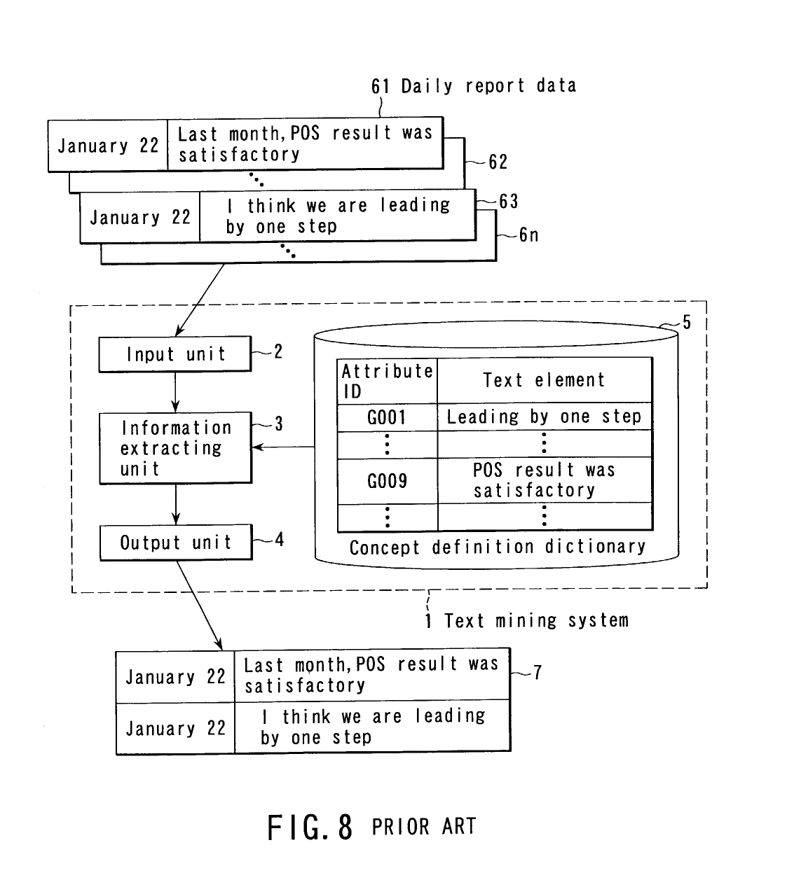

The information extracting unit 3a acquires daily report data from the input unit 2a and executes text mining similar to the analysis described above with reference to FIG. 8 on the basis of text elements and attribute IDs provided from the extracting unit 13, thereby generating an analysis result file.

Table 4 shows an example of the analysis result file generated by the information extracting unit 3a.

In this analysis result file, daily report numbers, daily report data, and analysis result information are linked to each other. More specifically, the analysis result file is a table having items “daily report number”, “daily report data”, and “analysis result information”.

TABLE 4
Contents of analysis result file

| Daily | | Analysis |
|---|---|---|
| report | | result |
| number | Daily report data | information |
| N001 | Daily report data on | G009 |
| | January 22: Last month, | |
| | POS result was | |
| | satisfactory | |
| N002 | I think we are leading | NULL |
| | by one step | |
| N003 | We made arrangements | G011 |
| | about sale expansion | |
| | method | |
| N004 | Merchandise shipment at | G007 |
| | weekend was reported | |
| | active regardless of | |
| | snow | |
| N005 | Sales are continuously | G012 |
| | good from beginning of | |
| | this year | |

The analysis result information is the attribute ID of a text element contained in the daily report data related to date “January 22” designated by the user and linked to pieces of category information “high” and “medium” designated by the user. Analysis result information of daily report data that is daily report data of the date designated by the user at all but contains no text elements linked to pieces of category information “high” and “medium” designated by the user is “NULL”.

The output unit 4a receives the analysis result file from the information extracting unit 3a and displays only daily report data whose analysis result information is not “NULL”, i.e., daily report data with an attribute ID inserted into the analysis result information.

Table 5 shows an analysis result obtained when the user 15 designates date “January 22”, dictionary information “G1”, and pieces of category information “high” and “medium”.

TABLE 5
Analysis result (category information
“high” and “medium” are designated)

| Daily | |
|---|---|
| report | |
| number | Daily report data |
| N001 | Daily report data on January 22: Last |
| | month, POS result was satisfactory |
| N003 | We made arrangements about sale |
| | expansion method |
| N004 | Merchandise shipment at weekend was |
| | reported active regardless of snow |
| N005 | Sales are continuously good from |
| | beginning of this year |

In Table 5, only daily report data containing text elements linked to pieces of category information “high” and “medium” are extracted from daily report data related to date “January 22”.

Table 6 shows an analysis result obtained when the user 15 designates date “January 22”, dictionary information “G1”, and category information “medium”.

TABLE 6
Analysis result (category information
“medium” is designated)

| Daily | |
|---|---|
| report | |
| number | Daily report data |
| N003 | We made arrangements about sale |
| | expansion method |
| N004 | Merchandise shipment at weekend was |
| | reported active regardless of snow |

In Table 6, daily report data containing text elements linked to category information “medium” are extracted from daily report data of date “January 22”.

FIG. 3 is a flow chart related to a data analysis method executed by the data element designating system 8 and text mining system la.

In step S1, the recording unit 11 records information in which the attribute ID and category information of a text element are linked to the text element in the concept definition dictionary 14 of the computer system 10 in accordance with the operation of the user 15.

In step S2, the user 15 instructs to start data analysis. The category designating unit 12 displays the category designating window 16.

The user designates various kinds of desired information to be used for analysis on the category designating window 16.

In step S3, the category designating unit 12 receives the contents designated by the user 15.

In step S4, the extracting unit 13 extracts from designated dictionary information text elements and attribute IDs linked to the designated category information and provides the information to the information extracting unit 3a.

In step S5, the input unit 2a receives daily report data of the designated date from the daily report database 17.

In step S6, the information extracting unit 3a executes data analysis on the basis of the daily report data of the predetermined date received by the input unit 2a and the text elements and attribute IDs provided by the extracting unit 13.

In step S7, the output unit 4a outputs the analysis result.

Steps S4 and S5 may be executed in a reversed order or in parallel.

As described above, in this embodiment, category information is linked to a text element and its attribute ID in advance. In executing analysis processing, the user 15 designates the category information of a text element to be used for this analysis processing.

Accordingly, the user 15 need not change the contents of the concept definition dictionary 14 using a text editor and can easily switch text elements to be used for analysis by designating category information.

Hence, analysis desired by the user can easily be executed.

Even when the pieces of dictionary information are put together, a plurality of analysis processes can be executed.

Even a user who does not know the structure of the text mining system la well can easily change the contents of various kinds of dictionary information of the concept definition dictionary 14 in accordance with analysis contents using the GUI of the recording unit 11.

The user 15 can easily change the concept definition dictionary 14 using the recording unit 11 and prevent any bug based on a coding error or the like.

(Second Embodiment)

In this embodiment, a modification to the first embodiment will be described.

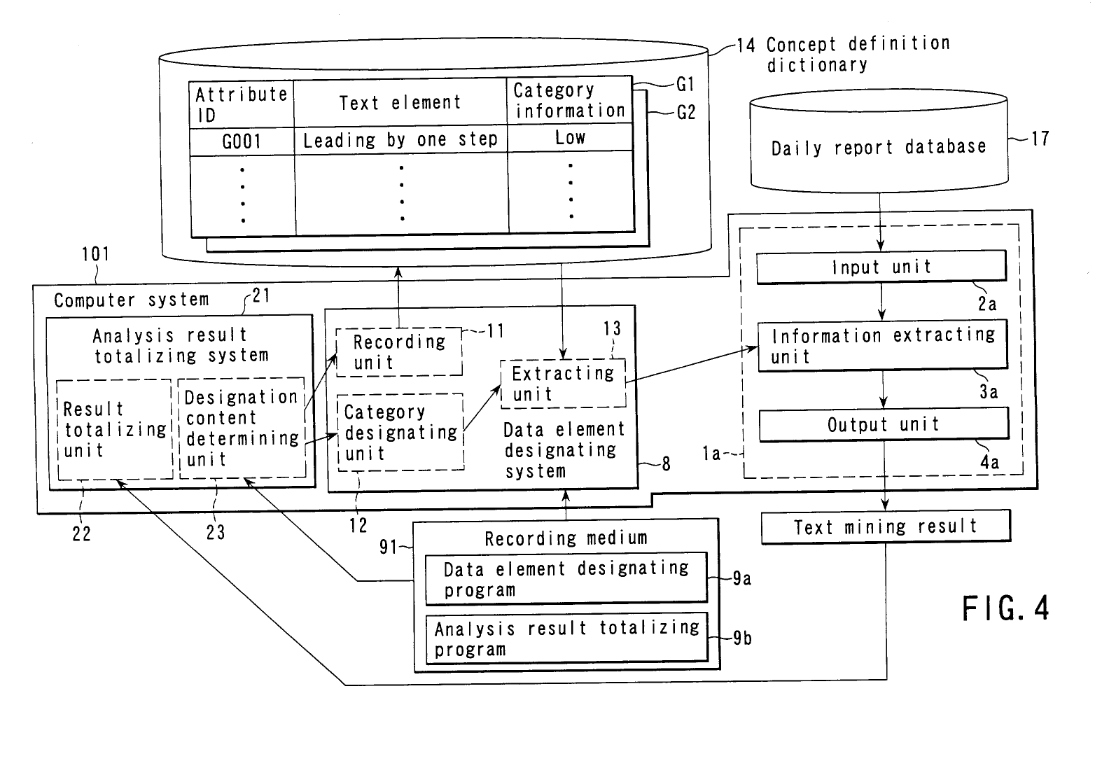

FIG. 4 is a block diagram showing an example of a data element designating system according to this embodiment. The same reference numerals as in FIG. 1 denote the same parts in FIG. 4, and a description thereof will be omitted. Only different parts will be described here in detail.

A computer system 101 loads and executes a data element designating program 9a and analysis result totalizing program 9b recorded on a recording medium 91.

The analysis result totalizing program 9b loaded to the computer system 101 makes the computer system 101 function as an analysis result totalizing system 21.

A data element designating system 8 according to this embodiment receives a designation of category information and the changed contents of a concept definition dictionary 14 not from a user 15 but from the analysis result totalizing system 21.

The analysis result totalizing system 21 comprises a result totalizing unit 22 and designation content determining unit 23.

The result totalizing unit 22 receives a text mining result in the past and extracts text elements contained in the text mining result.

Text element extraction by the result totalizing unit 22 may be executed by a method of extracting from the text mining result a text element recorded in the concept definition dictionary 14. Alternatively, text element extraction by the result totalizing unit 22 may be implemented by a method of separating daily report data contained in the text mining result in accordance with a predetermined rule and extracting text elements. For example, a rule for extracting words is used as the predetermined rule.

The result totalizing unit 22 also totalizes information such as an appearance frequency that indicates how many times an extracted text element is contained in text mining results and the appearance time of the extracted text element.

For example, time information added to daily report data or information representing the text mining execution time is used as information representing the appearance time of an extracted text element.

The designation content determining unit 23 links category information to each text element contained in the text mining result in the past. For example, for a text element contained in the text mining result in the past, category information “high appearance frequency”, “medium appearance frequency”, or “low appearance frequency” is linked to the text element in accordance with its appearance frequency. For a text element contained in the text mining result in the past, category information “within predetermined period” or “outside predetermined period” is linked to the text element in accordance with its appearance time.

The designation content determining unit 23 notifies the recording unit 11 and category designating unit 12 of the linked information (a text element and category information).

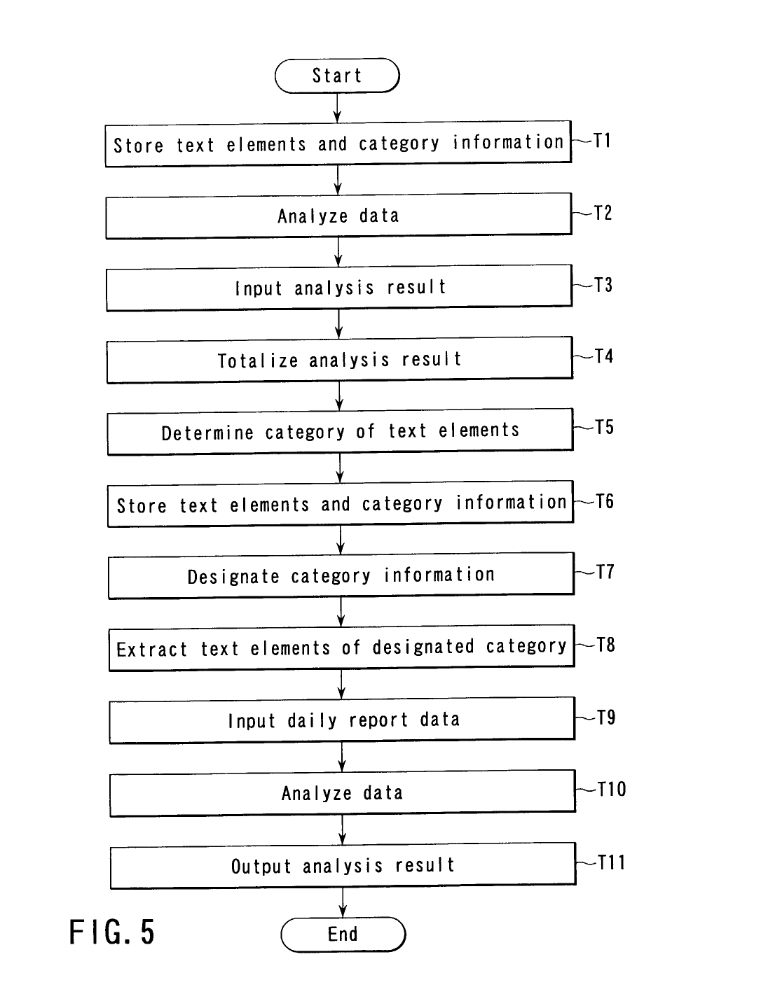

FIG. 5 is a flow chart related to a data analysis method executed by the data element designating system 8, text mining system la, and analysis result totalizing system 21.

In step T1, the recording unit 11 records in the concept definition dictionary 14 of the computer system 101 information in which the attribute ID and category information of a text element are linked to the text element.

In step T2, a text mining system la executes data analysis.

In step T3, the analysis result totalizing system 21 receives the analysis result of the text mining system la.

In step T4, the result totalizing unit 22 of the analysis result totalizing system 21 executes totalizing processing for the analysis result.

In step T5, the result totalizing unit 22 obtains information which links a text element contained in the analysis result and category information.

In step T6, the designation content determining unit 23 notifies the recording unit 11 of the linked information. The recording unit 11 of the data element designating system 8 records in the concept definition dictionary 14 of the computer system 101 the information in which category information is linked to the text element.

In step T7, the designation content determining unit 23 designates, for the category designating unit 12 of the data element designating system 8, predetermined category information to be processed in the totalizing processing by the result totalizing unit 22.

In step T8, an extracting unit 13 extracts from dictionary information the text elements and attribute IDs that are linked to the designated category information and provides them to an information extracting unit 3a.

In step T9, an input unit 2a receives daily report data from the daily report database 17.

In step T10, the information extracting unit 3a executes data analysis on the basis of the daily report data received by the input unit 2a and the text elements and attribute IDs provided by the extracting unit 13.

In step T11, an output unit 4a outputs the analysis result.

Steps T6 and T7 may be executed in a reversed order or in parallel.

In addition, steps T8 and T9 may be executed in a reversed order or in parallel.

The result totalizing unit 22 may present the totalizing result to the user 15 in a form of a table or a graph. The user 15 may input various kinds of determined matters such as category information to the designation content determining unit 23 on the basis of the presented contents.

In this embodiment, text elements are automatically grouped by the analysis result totalizing system 21, so text mining can be done using only text elements belonging to a predetermined category.

For example, text mining can be done using only text elements used at a predetermined frequency or more in preceding analysis while excluding text elements whose use frequency is lower than the predetermined level.

(Third Embodiment)

In this embodiment, a modification of the data element designating system 8 according to the first or second embodiment will be described.

Table 7 shows an example of dictionary information recorded by the recording unit of a data element designating system according to this embodiment.

TABLE 7
Dictionary information

| Attribute | | Category |
|---|---|---|
| ID | Text element | information |
| G001 | Drink | Drink |
| G002 | Shipment was active | Good, medium |
| G003 | Monthly sales are | Good, medium |
| | satisfactory | |
| G004 | Magazine | Magazine |
| G005 | POS result decreases | Bad |
| G006 | Book order | Magazine |
| G007 | Orange juice | Drink |
| G008 | Green tea | Drink |
| G009 | POS result was | Good, high |
| | satisfactory | |
| G010 | Monthly ◯◯ | Magazine |
| G011 | Unsatisfactory | Bad |
| G012 | Weekly magazine | Magazine |

In this embodiment, dictionary information in which each text element has one or more pieces of category information is recorded in a concept definition dictionary.

As category information, for example, “high”, “medium”, and “low” related to importance classification, “good” and “bad” related to quality classification, and “drink” and “magazine” related to article name classification are used.

When one piece of dictionary information contains various kinds of classifications (when a plurality of pieces of dictionary information in the first embodiment are combined), various kinds of data analysis can be executed using one piece of dictionary information.

Conventionally, a plurality of pieces of dictionary information are prepared and selectively used for text mining in accordance with analysis contents. In this embodiment, however, various kinds of text mining can be executed using one piece of dictionary information. Hence, the user need not designate dictionary information to be used for analysis processing so that the user operation can be simplified.

(Fourth Embodiment)

In this embodiment, a modification of the data element designating system of the third embodiment will be described. The same arrangement as that shown in FIG. 1 or 4 can be used for this embodiment.

In this embodiment, category information is formed by hierarchically combining categories.

Table 8 shows an example of dictionary information recorded by the recording unit of the data element designating system according to this embodiment.

TABLE 8
Dictionary information

| Attribute | | Attribute | Category |
|---|---|---|---|
| ID | Text element | number | information |
| G002 | Shipment was | G-M | Good—medium |
| | active | | |
| G003 | Monthly | G-M | Good—medium |
| | sales are | | |
| | satisfactory | | |
| G009 | POS result | G-H | Good—high |
| | was | | |
| | satisfactory | | |
| G013 | Even sales | G-L | Good—low |
| | | B | Bad |

In this embodiment, dictionary information in which category information with a hierarchical structure is added to each text element is recorded in a concept definition dictionary.

For example, text elements are classified first into two categories, “good” and “bad”, related to quality classification. Second, text elements belonging to category “good” are subclassified into three categories “high”, “medium”, and “low” related to importance analysis.

Text elements representing good meaning also include text elements with high degree of importance and those with low degree.

In this embodiment, when the dictionary information shown in Table 8 is used, the user can execute data analysis using, e.g., only text element with high degree of importance from the text elements representing good meaning.

An attribute number in Table 8 represents the hierarchical state of the category to which the text element belongs. Each attribute number is linked to a text element, like category information.

For example, number “G” is assigned to category “good”. Number “H” is assigned to category “high”. Number “M” is assigned to category “medium”. Number “L” is assigned to category “low”. The number of an upper category and that of a lower category are connected by “−”.

A text element may be linked to one or more pieces of category information and recorded in the dictionary information.

For example, pieces of category information “good-low” and “bad” may be added to text element “even sales”.

In this embodiment, category information having a hierarchical structure and that having no hierarchical structure may be recorded in single dictionary information.

Table 9 shows an example of the contents of dictionary information in which both category information having a hierarchical structure and that having no hierarchical structure are recorded.

TABLE 9
Dictionary information

| Attribute | | Attribute | Category |
|---|---|---|---|
| ID | Text element | number | information |
| G001 | Drink | D-A | Drink—all |
| G002 | Shipment was | G-M | Good—medium |
| | active | | |
| G003 | Monthly sales | G-M | Good—medium |
| | are | | |
| | satisfactory | | |
| G004 | Magazine | MA-NULL | Magazine |
| G005 | POS result | B-NULL | Bad |
| | decreases | | |
| G006 | Book order | MA-NULL | Magazine |
| G007 | Orange juice | D-F | Drink—fruit |
| G008 | Green tea | D-T | Drink—tea |
| G009 | POS result was | G-H | Good—high |
| | satisfactory | | |
| G010 | Monthly ◯◯ | MA-NULL | Magazine |
| G011 | Unsatisfactory | B-NULL | Bad |
| G012 | Weekly | MA-NULL | Magazine |
| | magazine | | |
| G013 | Even sales | G-L | Good—low |
| | | B-NULL | Bad |

In the example shown in Table 9, text elements are classified first into categories “drink”, “magazine”, “good”, and “bad”. Second, text elements belonging to category “drink” are classified into categories “general”, “tea”, and “fruit”, and text elements belonging to category “good” are classified into categories “high”, “medium”, and “low”.

That is, in Table 9, category information representing category “drink” or “good” has a hierarchical structure while category information representing category “magazine” or “bad” has no hierarchical structure.

Attribute numbers “D”, “G”, “MA”, and “B” are assigned to upper categories “drink”, “good”, “magazine”, and “bad”, respectively.

Attribute numbers “A”, “T”, “F”, “H”, “M”, and “L” are assigned to lower categories “general”, “tea”, “fruit”, “high”, “medium”, and “low”, respectively. If no lower category is present, attribute number “NULL” is assigned.

Category information does not always have a two-layered hierarchical structure such as “good—high” and may have a three or more—layered hierarchical structure such as “good—high—continue” or “good—high—short-term”.

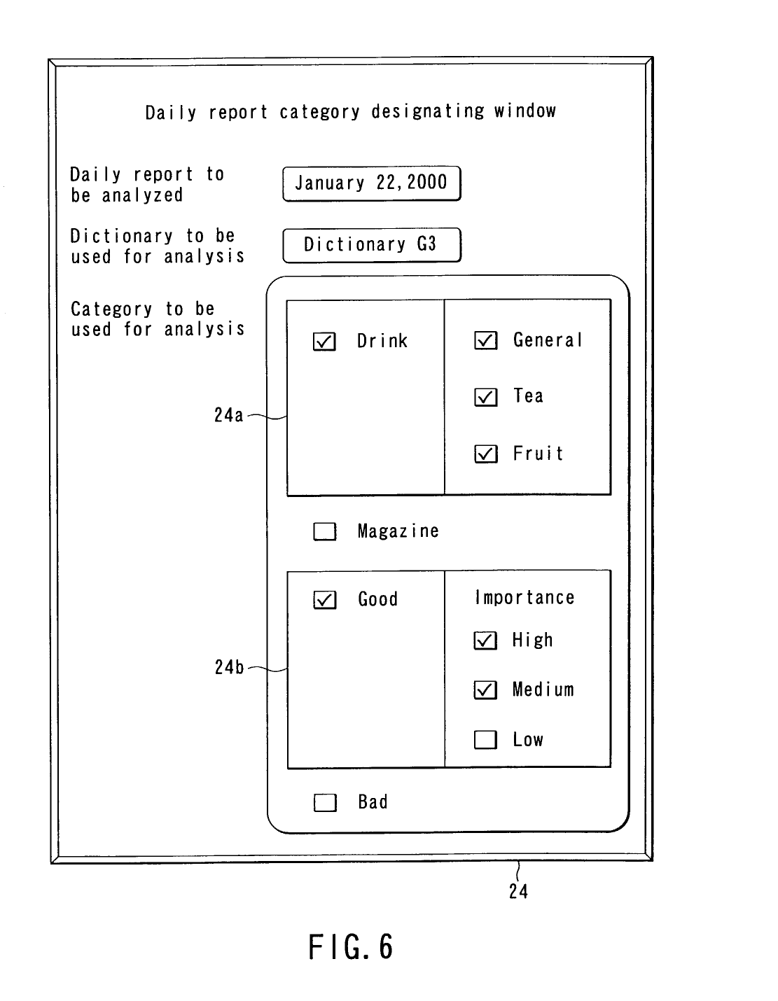

FIG. 6 is a view showing an example of a window which receives a category designation from the user when analysis is to be executed using the dictionary information according to this embodiment.

In accordance with a category designating window 24, a user designates daily report data to be analyzed, designates dictionary information to be used for analysis, and at least one upper category. When the designated upper category has a lower category, a category designating unit according to this embodiment displays options 24a and 24b to designate lower categories.

The user designates lower categories in according with the options 24a and 24b.

An extracting unit according to this embodiment extracts text elements belonging to the categories designated on the category designating window 24. The extracted text elements are used for analysis of daily report data.

In this embodiment described above, category information linked to each text element recorded in the concept definition dictionary has a hierarchical structure.

Accordingly, the user can execute analysis while designating, e.g., only upper categories and then execute analysis while designating lower categories in accordance with the analysis result to narrow down the analysis result. The user can execute analysis according to his/her will.

The layout of the units in the data element designating system according to each of the above embodiments may be changed as long as the same function as described above can be implemented. The units may be freely combined.

In each of the above embodiments, the computer system may be constituted by a plurality of computers. Programs may be distributed to the plurality of computers such that processing is executed by the computers cooperating with each other.

The program according to each of the above embodiments can be written in a recording medium such as a magnetic disk (flexible disk, hard disk, or the like), an optical disk (CD-ROM, DVD, or the like), or a semiconductor memory and applied to the computer. The program may be transmitted through a communication medium and applied to the computer. The computer that implements the functions of the various kinds of units loads the program recorded in a recording medium such that operation is controlled by the program, thereby implementing the functions of the above-described units.

(Fifth Embodiment)

In this embodiment, a use form of the data element designating system according to each of the above embodiments will be described.

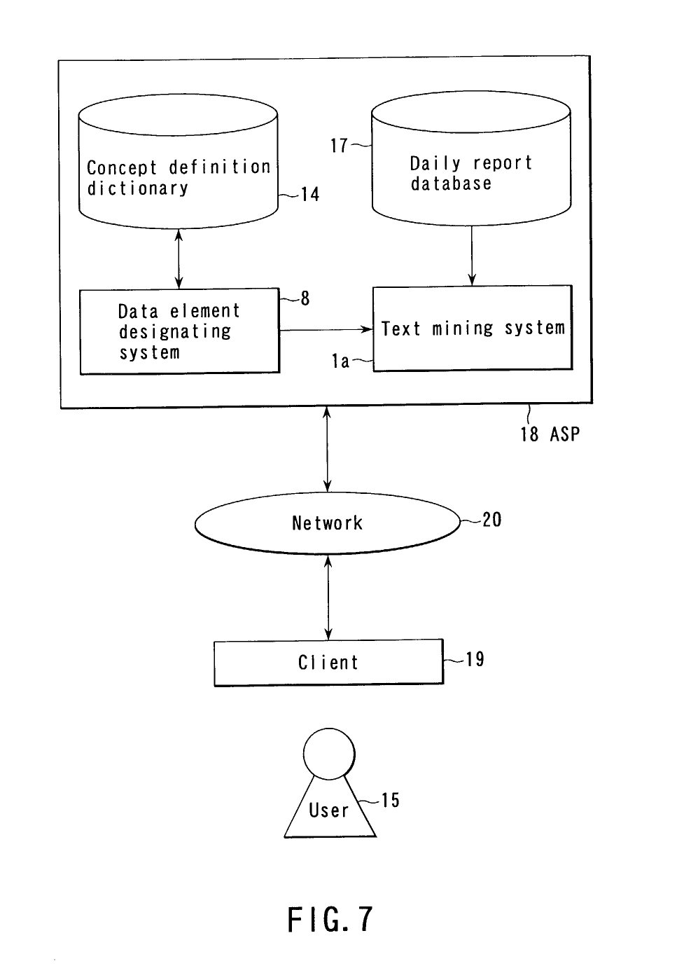

FIG. 7 is a block diagram showing an example of a use form of a data element designating system according to this embodiment. The same reference numerals as in FIG. 1 denote the same parts in FIG. 7.

A service executed by a text mining system la shown in FIG. 7 is provided to a user 15 by an ASP (Application Service Provider) 18.

A service executed by a data element designating system 8 is also provided by the ASP 18.

The user 15 uses the text mining system la managed by the ASP 18 from his/her own client 19 through a network 20 such as the Internet. Thus, the user 15 can easily analyze daily report data.

In addition, when the user 15 wants to change text elements to be used for analysis or change the contents of dictionary information, he/she can easily change the text elements or dictionary information by using the data element designating system 8 managed by the ASP 18.

In addition, by receiving the service of the ASP 18, the user 15 can efficiently use the analysis service in terms of maintenance and operation as compared to a case wherein the user 15 operates the text mining system la and data element designating system 8 by himself/herself.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A computer readable medium having computer readable program code means embodied therein, the computer program code means comprising:
a computer readable program code that records in a dictionary database dictionary information which is used for processing of determining whether a predetermined data element is contained in data to be analyzed and links a data element and category information representing at least one category to which the data element belongs;
a computer readable program code that receives a designation of the category; and
a computer readable program code that extracts a data element linked to category information representing the designated category by referring to the dictionary database and sets the extracted data element as the predetermined data element to be used for determination in the processing.

2. The medium according to claim 1, comprising
a computer readable program code that extracts a candidate data element contained in the data to be analyzed in accordance with a predetermined rule when it is determined by the processing that the predetermined data element is contained in the data to be analyzed, totalizes an extraction frequency of the candidate data element, and records in the database dictionary information which links the candidate data element and category information representing the extraction frequency of the candidate data element.

3. The medium according to claim 1, comprising
a computer readable program code that extracts a candidate data element contained in the data to be analyzed in accordance with a predetermined rule when it is determined by the processing that the predetermined data element is contained in the data to be analyzed, extracts time information added to the data to be analyzed, and records in the database dictionary information which links the candidate data element and category information representing the extracted time information.

4. The medium according to claim 1, wherein
the category information has a structure obtained by hierarchically combining a plurality of categories, and
the designation of the category represents the hierarchical combination of the plurality of categories.

5. A data analysis system which executes processing of determining whether a predetermined data element is contained in data to be analyzed, comprising:
a recording unit that records in a dictionary database dictionary information which links a data element and category information representing at least one category to which the data element belongs;
a category designating unit that receives a designation of the category; and
an extracting unit that extracts a data element linked to category information representing the designated category by referring to the dictionary database and sets the extracted data element as the predetermined data element to be used for determination in the processing.

6. The system according to claim 5, comprising
a totalizing unit that extracts a candidate data element contained in the data to be analyzed in accordance with a predetermined rule when it is determined by the processing that the predetermined data element is contained in the data to be analyzed, totalizes an extraction frequency of the candidate data element, and records in the database dictionary information which links the candidate data element and category information representing the extraction frequency of the candidate data element.

7. The system according to claim 5, comprising
a totalizing unit that extracts a candidate data element contained in the data to be analyzed in accordance with a predetermined rule when it is determined by the processing that the predetermined data element is contained in the data to be analyzed, extracts time information added to the data to be analyzed, and records in the database dictionary information which links the candidate data element and category information representing the extracted time information.

8. The system according to claim 5, wherein
the category information has a structure obtained by hierarchically combining a plurality of categories, and
the designation of the category represents the hierarchical combination of the plurality of categories.

9. A data analysis method of executing processing of determining whether a predetermined data element is contained in data to be analyzed, comprising:
recording in a dictionary database dictionary information which links a data element and category information representing at least one category to which the data element belongs;
receiving a designation of the category; and
extracting a data element linked to category information representing the designated category by referring to the dictionary database and setting the extracted data element as the predetermined data element to be used for determination in the processing.

10. The method according to claim 9, comprising
extracting a candidate data element contained in the data to be analyzed in accordance with a predetermined rule when it is determined by the processing that the predetermined data element is contained in the data to be analyzed, totalizing an extraction frequency of the candidate data element, and recording in the database dictionary information which links the candidate data element and category information representing the extraction frequency of the candidate data element.

11. The method according to claim 9, comprising
extracting a candidate data element contained in the data to be analyzed in accordance with a predetermined rule when it is determined by the processing that the predetermined data element is contained in the data to be analyzed, extracting time information added to the data to be analyzed, and recording in the database dictionary information which links the candidate data element and category information representing the extracted time.

12. The method according to claim 9, wherein
the category information has a structure obtained by hierarchically combining a plurality of categories, and
the designation of the category represents the hierarchical combination of the plurality of categories.
